(19) United States
(12) Patent Application Publication
(10) Pub. No.: US 2025/0358359 A1
(43) Pub. Date: Nov. 20, 2025

(54) VEHICLE BASED CALL SCREENING AND REACTION SYSTEM

(71) Applicant: Ford Global Technologies, LLC, Dearborn, MI (US)

(72) Inventors: Keith Weston, Canton, MI (US); John Robert Van Wiemeersch, Novi, MI (US); Andrew Brown, Royal Oak, MI (US); Brendan F. Diamond, Naples, FL (US)

(21) Appl. No.: 18/663,850

(22) Filed: May 14, 2024

(51) Int. Cl. H04M 1/72454; H04M 1/72409; H04M 1/72484; H04M 3/436

(52) U.S. Cl. CPC H04M 1/72454; H04M 1/724098; H04M 1/72484; H04M 3/436

(57) ABSTRACT

An incoming call is received to a vehicle. A call answering application of the vehicle determines, based on vehicle data from one or more in-vehicle networks and map data indicative of roadway segments to be traversed by the vehicle, a cognitive load of an occupant of the vehicle. The call answering application determines a suggested disposition of the incoming call. Responsive to the cognitive load exceeding a cognitive threshold, the suggested disposition of the incoming call is automatically performed. Otherwise, an incoming call message is displaying, to a human-machine interface (HMI) of the vehicle, the incoming call message indicating call identifying information and providing a set of controls to allow the occupant to select a disposition for the incoming call, wherein the suggested disposition is indicated in the incoming call message as being a default disposition for the incoming call.

### TECHNICAL FIELD

Aspects of the disclosure generally relate to vehicle based call screening and reaction systems.

### BACKGROUND

Many automotive systems offer the ability to interact with a phone via a vehicle-based human-machine interface (HMI). When an occupant of a vehicle receives a call, a call user interface may be displayed to the HMI. This call user interface may include an indication that a call is incoming as well as the number or contact who is calling. The call user interface may also include an accept control that allows the user to answer the call using the vehicle HMI, and a second control that rejects the call.

### SUMMARY

In one or more illustrative examples, a method for call screening for a vehicle includes receiving an incoming call to the vehicle; determining, by a call answering application of the vehicle, based on vehicle data from one or more in-vehicle networks and map data indicative of roadway segments to be traversed by the vehicle, a cognitive load of an occupant of the vehicle; determining, by the call answering application, a suggested disposition of the incoming call; responsive to the cognitive load exceeding a cognitive threshold, automatically perform the suggested disposition of the incoming call; and otherwise, displaying, to a human-machine interface (HMI) of the vehicle, an incoming call message, the incoming call message indicating call identifying information and providing a set of controls to allow the occupant to select a disposition for the incoming call, wherein the suggested disposition is indicated in the incoming call message as being a default disposition for the incoming call.

In one or more illustrative examples, a system for call screening for a vehicle, includes one or more controllers of a vehicle, configured to receive an incoming call to the vehicle; determine, by a call answering application of the vehicle, based on vehicle data from one or more in-vehicle networks and map data indicative of roadway segments to be traversed by the vehicle, a cognitive load of an occupant of the vehicle; determine, by the call answering application, a suggested disposition of the incoming call; responsive to the cognitive load exceeding a cognitive threshold, automatically perform the suggested disposition of the incoming call; and otherwise, display, to a human-machine interface (HMI) of the vehicle, an incoming call message, the incoming call message indicating call identifying information and providing a set of controls to allow the occupant to select a disposition for the incoming call, wherein the suggested disposition is indicated in the incoming call message as being a default disposition for the incoming call.

In one or more illustrative examples, a non-transitory computer-readable medium comprising instructions for a call screening for a vehicle that, when executed by one or more controllers of a vehicle, cause the one or more controllers to perform operations including to receive an incoming call to the vehicle; determine, by a call answering application of the vehicle, based on vehicle data from one or more in-vehicle networks and map data indicative of roadway segments to be traversed by the vehicle, a cognitive load of an occupant of the vehicle; determine, by the call answering application, a suggested disposition of the incoming call; responsive to the cognitive load exceeding a cognitive threshold, automatically perform the suggested disposition of the incoming call; and otherwise, display, to a human-machine interface (HMI) of the vehicle, an incoming call message, the incoming call message indicating call identifying information and providing a set of controls to allow the occupant to select a disposition for the incoming call, wherein the suggested disposition is indicated in the incoming call message as being a default disposition for the incoming call.

### BRIEF DESCRIPTION OF THE DRAWINGS

FIG. 1 illustrates an example diagram of a system configured to provide call answering services to a vehicle;

FIG. 2 illustrates an example of the data flow of a call answering application of the system of FIG. 1;

FIG. 3 illustrates an example human-machine interface of the call answering application of FIG. 2 for the disposition of an incoming call; and

FIG. 4 illustrates an example process for vehicle-based call screening and reaction performed by the call answering application of the system of FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Screening calls refers to a process where desired calls are answered but unwanted calls are ignored or blocked. A user may manually screen calls by reviewing the information in a call user interface and selecting either to accept or reject the call (or do nothing and allow the call to time out). In some cases, call screening may be done based on whether the phone number is included in the user's address book. Or call screening may be done by the user deciding whether the number appears to be a legitimate phone number, such as based on area code.

Sometimes a user may choose not to answer any numbers that are not in the address book. Yet, some highly desired callers have their phones set not to provide their phone number. This is common among those who use their phones to contact people for official purposes (such as doctors) who don't want the call recipients (such as patients) to have their personal phone number.

When a phone call is incoming, and the vehicle occupant's cognitive bandwidth is partially utilized by operating a motor vehicle, the occupant's ability and desire to screen that call may be reduced. This reduction in call screening may cause the occupant to unintentionally accept a spam call, robocalls, telemarketers, etc. Unintendedly answering the wrong call may also expose the user as a candidate for further unwelcome calls.

An improved call answering system may utilize the vehicle as a call screener. In a first aspect, the call answering system may detect if a call is flagged as spam (e.g., by the user's phone or by the cellular service provider). In such a case the call may be automatically blocked. When blocked, no incoming call user interface may be displayed to the vehicle occupants.

In a second aspect, the call answering system may verify whether the contact is in the user's address book and may allow the incoming call if the contact is known (and not set to silent or block in the user's address book). In this case, if the caller is known and allowable, the call user interface may be displayed to the vehicle occupants.

Yet, this leaves a third category of callers who are not known spam but are still not known callers. To address this additional category, the call answering system may provide the calls in the third category with a modified incoming call user interface.

The modified incoming call user interface may include a third choice, a screen-this-call control. When selected, the screen-this-call control may connect the caller with a computerized call answering system. This call answering system may perform various functions to validate that the incoming call is valid. In an example, the call answering system may answer the call and may wait for the caller to speak as a validation that the caller is not a robocall. Additionally, or alternately, the call answering system may also answer the call and provide question answer functionality if the driver has a high cognitive load due to vehicle driving tasks. The call answering system may also assume control of the call in various situations, including if the cognitive load of the driver increases, such that an important call is not lost due to the occupant becoming busy with the driving task. Further aspects of the disclosure are discussed in detail herein.

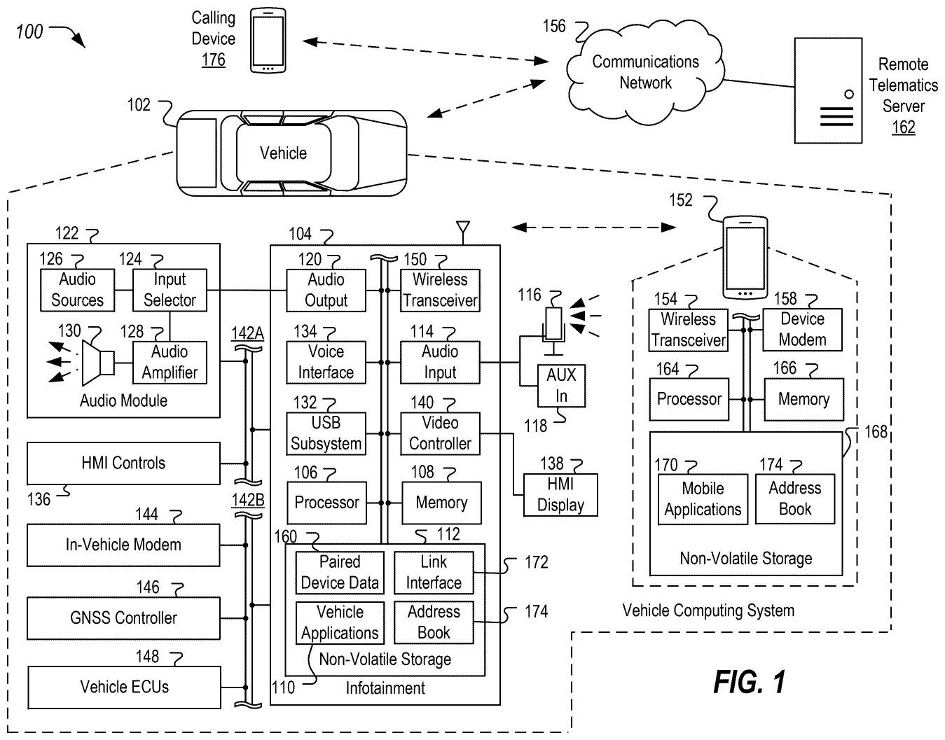

FIG. 1 illustrates an example diagram of a system 100 configured to provide call answering services to a vehicle 102. The vehicle 102 may include various types of passenger vehicle, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, MI. It should be noted that the illustrated system 100 is merely an example, and more, fewer, and/or differently located elements may be used.

An infotainment system 104 may include one or more processors 106 configured to perform instructions, commands and other routines in support of the processes described herein. For instance, the infotainment system 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable medium 112. The computer-readable medium 112 (also referred to as a processor-readable medium or storage) includes any non-transitory medium (e.g., a tangible medium) that participates in providing instructions or other data that may be read by the processor 106 of the infotainment system 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and structured query language (SQL).

The infotainment system 104 may be provided with various features allowing the vehicle occupants to interface with the infotainment system 104. For example, the infotainment system 104 may include an audio input 114 configured to receive spoken commands from vehicle occupants through a connected microphone 116, and auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The infotainment system 104 may also provide one or more audio outputs 120 to an input of an audio module 122 having audio playback functionality. In other examples, the infotainment system 104 may provide the audio output 120 to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM) or frequency modulated (FM) radio signals, and audio signals from compact disc (CD) or digital versatile disk (DVD) audio playback. The audio sources 126 may also include audio received from the infotainment system 104, such as audio content generated by the infotainment system 104, audio content decoded from flash memory drives connected to a universal serial bus (USB) subsystem 132 of the infotainment system 104, and audio content passed through the infotainment system 104 from the auxiliary audio input 118.

The infotainment system 104 may utilize a voice interface 134 to provide a hands-free interface to the infotainment system 104. The voice interface 134 may support speech recognition from audio received via the microphone 116 according to grammar associated with available commands, and voice prompt generation for output via the audio module 122. In some cases, the system may be configured to temporarily mute or otherwise override the audio source 126 specified by the input selector 124 when an audio prompt is ready for presentation by the infotainment system 104 and another audio source 126 is selected for playback.

The infotainment system 104 may also receive input from HMI controls 136 configured to provide for occupant interaction with the vehicle 102. For instance, the infotainment system 104 may interface with one or more buttons or other HMI controls 136 configured to invoke functions on the infotainment system 104 (e.g., steering wheel audio buttons, a push-to-talk button, instrument panel controls, etc.). The infotainment system 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a screen only, without touch input capabilities.

The infotainment system 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the infotainment system 104 to communicate with other vehicle 102 systems, such as a vehicle modem 144 (which may not be present in some configurations), a global navigation satellite system (GNSS) module 146 configured to provide current vehicle 102 location and heading information, and various vehicle electronic control units (ECUs) 148 configured to corporate with the infotainment system 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

As shown, the audio module 122 and the HMI controls 136 may communicate with the infotainment system 104 over a first in-vehicle network 142-A, and the vehicle modem 144, GNSS module 146, and vehicle ECUs 148 may communicate with the infotainment system 104 over a second in-vehicle network 142-B. In other examples, the infotainment system 104 may be connected to more or fewer in-vehicle networks 142. Additionally, or alternately, one or more HMI controls 136 or other components may be connected to the infotainment system 104 via different in-vehicle networks 142 than shown, or directly without connection to an in-vehicle network 142.

The infotainment system 104 may also be configured to communicate with mobile devices 152 of the occupants of the vehicle 102. The mobile devices 152 may be any of various types of portable computing device, such as cellular phones, tablet computers, smart watches, laptop computers, portable music players, or other devices capable of communication with the infotainment system 104. In many examples, the infotainment system 104 may include a wireless transceiver 150 (e.g., a BLUETOOTH module, an Ultra-Wideband (UWB) transceiver, a Wi-Fi transceiver, a ZIGBEE transceiver, an IrDA transceiver, a radio frequency identification (RFID) transceiver, etc.) configured to communicate with a compatible wireless transceiver 154 of the mobile device 152. Additionally, or alternately, the infotainment system 104 may communicate with the mobile device 152 over a wired connection, such as via a USB connection between the mobile device 152 and the USB subsystem 132. In some examples the mobile device 152 may be battery powered, while in other cases the mobile device 152 may receive at least a portion of its power from the vehicle 102 via the wired connection.

A communications network 156 may provide communications services, such as packet-switched network services (e.g., Internet access, VOIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the infotainment system 104 may be identified by the infotainment system 104 according to paired device data 160 maintained in the computer-readable medium 112. The paired device data 160 may indicate, for example, the unique device identifiers of mobile devices 152 previously paired with the infotainment system 104 of the vehicle 102, secret information shared between the paired device and the infotainment system 104 such as link keys, and/or personal identification numbers (PINs), and most recently used or device priority information, such that the infotainment system 104 may automatically reconnect to the mobile devices 152 matching data in the paired device data 160 without user intervention.

When a mobile device 152 that supports network connectivity is connected to the infotainment system 104, the mobile device 152 may allow the infotainment system 104 to use the network connectivity of the device modem 158 to communicate over the communications network 156 with a remote telematics server 162 or other remote computing device. In one example, the infotainment system 104 may utilize a data-over-voice plan or data plan of the mobile device 152 to communicate information between the infotainment system 104 and the communications network 156. Additionally, or alternately, the infotainment system 104 may utilize the vehicle modem 144 to communicate information between the infotainment system 104 and the communications network 156, without use of the communications facilities of the mobile device 152.

Similar to the infotainment system 104, the mobile device 152 may include one or more processors 164 configured to execute instructions of mobile applications loaded to a memory 166 of the mobile device 152 from storage medium 168 of the mobile device 152. In some examples, the mobile applications may be configured to communicate with the infotainment system 104 via the wireless transceiver 154 and with the remote telematics server 162 or other network services via the device modem 158. The infotainment system 104 may also include a device link interface 172 to facilitate the integration of functionality of the mobile applications into the grammar of commands available via the voice interface 134. The device link interface 172 may also provide the mobile applications with access to vehicle functions and information available to the infotainment system 104 via the in-vehicle networks 142. An example of a device link interface 172 may be the SYNC APPLINK component of the SYNC system provided by The Ford Motor Company of Dearborn, MI.

In some examples, the vehicle 102 may maintain an address book 174 of names and phone numbers of contacts who may call the vehicle 102 using contact communication devices 176. The contacts refer to data records that each define information about a contact and the contact communication devices 176 of the contact that may be called or that may receive calls. In an example, the contacts may indicate a name of a contact, and one or more identifiers that may be used to send or receive communications with the contact. These identifiers may include, as some non-limiting examples, phone numbers, instant message account names, online user handles, email addresses, and so on. The contact communication devices 176 may include portable computing device, such as cellular phones, tablet computers, smart watches, laptop computers, portable music players, or other devices capable of call communication over cellular, Wi-Fi or other communications networks 156.

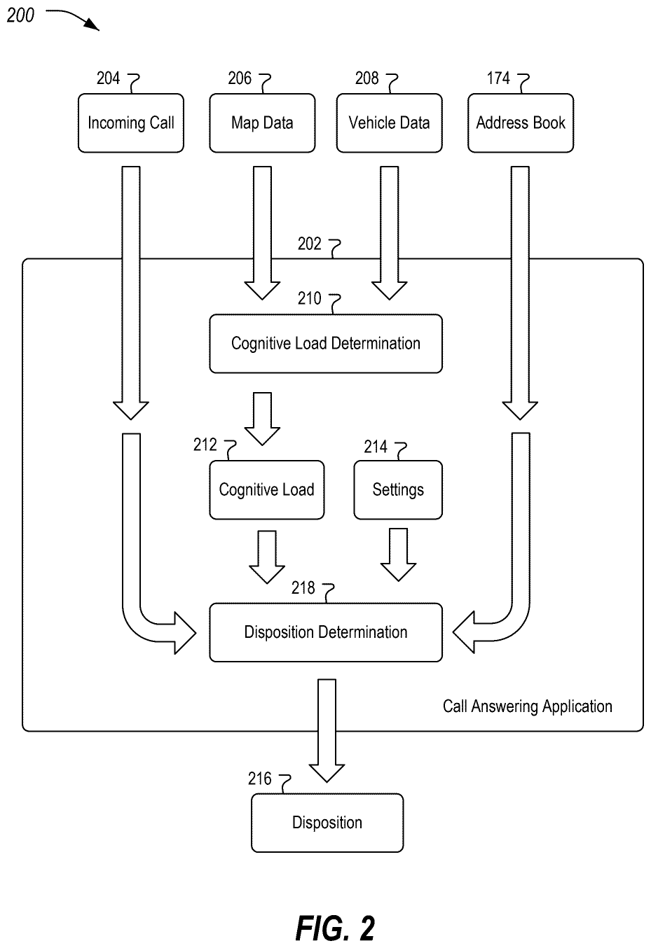

FIG. 2 illustrates an example 200 of the data flow of a call answering application 202. In an example, the call answering application 202 may be a vehicle application 110 installed to the vehicle 102. In other examples, the call answering application 202 may be implemented in whole or in part using the computing and network services of the remote telematics server 162. In yet another example, the call answering application 202 may be implemented in whole or in part using the computing and network services of the mobile device 152.

The call answering application 202 may receive an incoming call 204. In addition to the incoming call 204, the call answering application 202 may also receive input from various sources. The additional inputs to the call answering application 202 may include the address book 174, map data 206 indicative of the roadway segments that are to be traversed by the vehicle 102, and vehicle data 208 from the one or more in-vehicle networks 142. Using these inputs, a cognitive load component 210 of the call answering application 202 may determine cognitive load 212 of the driver. The call answering application 202 may also utilize settings 214 indicative of the preferences in handling the incoming call 204. Based on the cognitive load 212 and the settings 214, the call answering application 202 may identify a disposition 216 of the incoming call 204. Thus, the call answering application 202 may act as a personal secretary, managing incoming calls 204, e.g., those from numbers not stored in the address book 174. Only legitimate incoming calls 204 may be brought to the driver's attention, allowing for uninterrupted driving while the call answering application 202 handles call screening duties.

The incoming call 204, as discussed in detail herein, is a telephone call in many examples. However, it should be noted that the incoming call 204 may be any other type of invitation to initiate a real-time voice communication between the caller of the incoming call 204 and the occupant of the vehicle 102, such as a Facetime call, a Wi-Fi call, a video call, etc.

The map data 206 may include information about road segments, which are specific sections of roadways differentiated by features such as street names, speed limits, and connectivity to intersections. The map data 206 data may also include directional information indicating permissible travel directions on one-way streets or highway ramps. The map data 206 may also define locations of traffic signals and signs, which may be used to aid in traffic updates and routing options for the vehicle 102 traversing along a route.

The vehicle data 208 may include information about the operation of the vehicle 102 collected from a variety of vehicle ECUs 148 or other controllers of the vehicle 102. In an example, the vehicle data 208 may capture information such as speed of the vehicle 102, change in speed of the vehicle 102, etc. In another example, the vehicle data 208 may capture information such as environmental conditions, e.g., an amount of ambient light around the vehicle 102, a presence or absence of precipitation, a type of precipitation, and ambient temperature, etc. In another example, the GNSS module 146 may provide location data, which may be combined with the map data 206 to identify upcoming turns, merges, traffic controls, or other upcoming traffic events.

The cognitive load component 210 of the call answering application 202 may be utilized to estimate the cognitive load 212 of the driver or other occupants of the vehicle 102. As referred to herein, cognitive load 212 refers to the demand or load that a stimulus places on a human mind during user interaction with the stimulus.

In an example, the cognitive load component 210 may compare the map data 206 and vehicle data 208 with various rules that indicate the estimated cognitive load 212 of the occupants. For instance, if speed of the vehicle 102 exceeds a predefined threshold speed, or if a turn or merge is upcoming within a predefined time period at the current speed based on the map data 206 (e.g., possibility based on the current navigation route of the vehicle 102), then cognitive load 212 may be estimated to be high. Or, if the vehicle 102 is driving down a straight roadway without detected obstacles, then cognitive load 212 may be estimated to be lower.

In another example, cognitive load component 210 may utilize a machine learning model trained based on vehicle data 208 and predefined ground truth cognitive loads 212 for the corresponding vehicle data 208, where that model is used in an inference mode by the call answering application 202 to determine the current cognitive load 212 along a scale. A threshold value may be defined along this scale to determine a cutoff between low and high cognitive load.

The cognitive load component 210 may estimate the cognitive load 212 accounting for whether the vehicle 102 is in autonomous driving mode. If the occupant is driving manually, the cognitive load component 210 may estimate cognitive load 212 related to driving tasks, while if the occupant is driving autonomously, then the cognitive load component 210 may estimate the cognitive load 212 based on the more limited watching but not driving task. Thus, the cognitive load 212 of the occupant may be less if the cognitive load 212 is utilizing autonomous driving and/or semi-autonomous driving assist functions.

In another example, the cognitive load component 210 may consider the driving environment and the driver's familiarity with the road in the determination of cognitive load 212. In unfamiliar or dark areas, the cognitive load component 210 may estimate a higher cognitive load 212 on the driver as compared to in well-lit or familiar circumstances. In yet another example, the cognitive load component 210 may consider the location of the vehicle 102 relative to significant driving maneuvers. If the driver is nearing a major route change or about to enter a highway, the cognitive load component 210 may estimate a higher cognitive load 212 or a higher estimated upcoming cognitive load 212. In another example, the cognitive load component 210 may consider the presence of one or more passengers and ongoing interaction with the one or more passenger, such as for example, whether the passengers are children making requests of the driver or the like.

Factors that may be used in the determining of the cognitive load 212 may include monitoring activation state and/or history of one or more of the following: autonomous driving features, semi-autonomous driving features, stability control features, antilock brakes features, approaching off-ramps or intersections, selection of driving modes are selected such for slippery conditions or modes to assist in recovery of the vehicle 102, wheel torque surpassing a pre-set limit, State of Charge (SoC) of a battery of the vehicle 102 falling below a designated low point, powertrain temperatures (e.g., engine oil, transmission fluid, battery, or coolant) reaching predefined threshold levels, customs or checkpoints or border crossings, detection of police or emergency lights, detection of school bus stop signals, detection of audible sirens, approach to a trail crossing or capturing audio indicating of a train, detection of trailer sway, detection of manual trailer brakes application, activation of hazard lights, presence of severe weather, windshield wipers being triggered, etc. Based on these factors, the estimated cognitive load 212 of the driver may be raised or lowered.

The settings 214 may include data indicative of the preferences of the occupant of the vehicle 102 for handling incoming calls 204. The call answering application 202 may accordingly be set up via the settings 214 to categorize callers and handle them differently. Trusted callers may be presented with options to wait or be connected immediately based on predefined scenarios.

The settings 214 may, in some examples, be based on information included in the address book 174. The address book 174, as noted above, may include the names and numbers or other contact information. The address book 174 may also include other information, such as which contacts are priority contacts that are relatively more important to be put through to the occupant, alternate recipients to forwards calls to if the occupant is busy, etc. Certain contacts in the address book 174, deemed critical by the occupant such as a spouse, children, or emergency contacts, may be connected automatically through the call answering application 202 without driver intervention. These prioritized callers may receive a prompt message from the call answering application 202 informing them that they are being connected directly. For example, calls made using an emergency contact feature on the contact communication device 176, such as in situations where someone is incapacitated, may be provided through the call answering application 202 to the driver without intervention.

The settings 214 may specify for the call answering application 202 to automatically block calls listed in the address book 174 as to be blocked or indicated by the communications network 156 or the user's mobile device 152 as being likely spam. The remaining calls may be processed based on the additional inputs.

The settings 214 may also specify for the call answering applications 202 to filter incoming calls 204 based on time and day, as well as the identity of the caller. For example, during work hours or weekdays, the settings 214 may specify for incoming calls 204 from the workplace may be allowed through. Conversely, the settings 214 may specify for incoming calls 204 received during weekends or holidays to be greeted with a message instructing the caller to contact again during designated work times.

The settings 214 may also specify parameters to reduce distractions for new or teenage drivers. In an example, parents may be provided a setting 214 allowing the option to mute all incoming calls 204 during specified times, e.g., except those from approved contacts in the address book 174.

The settings 214 may also specify other updates to be performed by the vehicle 102 to facilitate the incoming call 204, such as lowering blower speed of the heating, ventilation, and air conditioning (HVAC) subsystem of the vehicle 102, closing windows, turning off audio playback of audio sources 126, etc.

The settings 214 may also specify for the call answering application 202 to emit fax tones or white noise in response to certain types of incoming call 204, a feature designed to deter robo callers. Generally, when robocall systems detect the sound of a fax machine, they mark the number as a non-human recipient that should not be called.

The settings 214 may also specify whether to use a speech obfuscator to alter the user's voice during calls. This feature may be invoked for unknown callers, to prevent the unknown callers from collecting sufficient voice samples to create machine-generated voice replicas (e.g., deepfakes) for illicit activities, such as unauthorized approvals or commitments.

The settings 214 may also specify whether or not to generate white noise during incoming calls 204 to prevent eavesdropping. This feature may be delivered in several ways. In an example, white noise may be employed via the speakers near other occupants in the vehicle 102. This may be done to mask the phone conversation, ensuring privacy, while the person on the incoming call 204 can hear the conversation clearly. In another example, such as for convertible models or other models with external speakers, the settings 214 may include an option to direct the call answering application 202 to activate the external speakers to emit white noise when stopped at traffic lights, stop signs, or moving slowly in traffic. This may prevent persons who are not occupants of the vehicle 102 from overhearing conversations within the vehicle 102.

Turning to the disposition 216, the disposition 216 may specify one or more actions to be performed by the call answering application 202 to handle the incoming call 204. These disposition 216 may include, as some non-limiting examples, to accept the incoming call 204, to reject or block the incoming call 204, to initiate a voice interface 134 session with the incoming call 204, to forward or otherwise redirect the incoming call 204, to interrupt the incoming call 204, etc.

A disposition determination 218 may be performed responsive to the incoming call 204, based on the cognitive load 212, the settings 214, and/or the address book 174. In some examples, the disposition 216 may be automatically performed by a disposition determination 218 of the call answering application 202. In other examples, the disposition determination 218 may provide the disposition 216 as a suggestion to the occupant via the display 138 or other HMI controls 136, which may be accepted by the user and/or automatically performed by the call answering application 202 if the user does not override the suggested disposition 216.

The suggested disposition 216 may be one of to accept the call incoming call 204 (e.g., because the disposition determination 218 finds no reason not to accept the incoming call 204), reject the incoming call 204 (e.g., because the disposition determination 218 finds that the call is likely spam), that the call answering application 202 should screen the incoming call 204 further, or that the call answering application 202 should handle the incoming call 204 itself (e.g., based on the cognitive load 212 of the driver).

In one aspect, the disposition determination 218 may be configured to evaluate the likelihood that an incoming call 204 is spam. Responsive to an incoming call 204 being received, and the caller not being in the address book 174, the disposition determination 218 may utilize the vehicle modem 144 to perform an Internet lookup of the caller's number. Depending on the search results, the disposition determination 218 may automatically reject numbers linked to spam or direct those calls to voicemail. If the number is associated with a legitimate business, the disposition determination 218 may cause the call answering application 202 or announce or display the business name through audible or visual cues in the HMI 300. The setting 214 may also define options for databases (e.g., white pages, yellow pages, database of blocked numbers, etc.) or other sources for configuring the screening process. In an example, responsive to users choosing to block callers e.g., via the HMI 300, the caller details may be sent to the remote telematics server 162. The remote telematics server 162 may collect the blocked numbers and compile a database that may be used by the call answering application 202 as a source of known spam numbers.

In another aspect, regarding initiating a voice interface 134 session with the incoming call 204, the disposition determination 218 may initiate the voice interface 134 for various purposes. In one non-limiting example, a machine learning algorithm, such as a long short-term memory (LSTM) neural network, may be implemented for voice analysis to classify incoming audio. This technology may discern whether the sound originates from a human or a non-human source. If the incoming call 204 does not include human voice, then the call answering application 202 may determine that the incoming call 204 is a potential robo-caller machine that awaits voice input from the recipient of the incoming call 204 before speaking. The call answering application 202 may block such incoming calls 204 without human audio.

In another example, the disposition determination 218 may utilize the voice interface 134 to ask questions to the incoming call 204. If the call is identified as a robocall or from a telemarketer who fails to correctly respond to pre-set questions, the call answering application 202 may terminate the call (e.g., hang up) and may block the number, all without distracting the driver.

In another aspect, the call answering application 202 may utilize the voice interface 134 to autonomously respond to common travel inquiries from certain predetermined contacts, such as those on a favorites list, a very important person (VIP) list, or an emergency contact list. This ensures the driver remains focused and undisturbed. For instance, if a person from the driver's favorites list calls, they may be redirected to the voice interface 134 of the call answering application 202 (e.g., if the user has a high cognitive load 212 or if the settings 214 indicate a preference for those users to use the voice interface 134 instead). The caller of the incoming call 204 may then ask questions to the call answering application 202 such as “Have you left yet?”, “Where are you?”, or “When will you arrive?”, and the call answering application 202 may automatically provide responses based on the vehicle data 208 and navigation information of the vehicle 102, all without interrupting the driver.

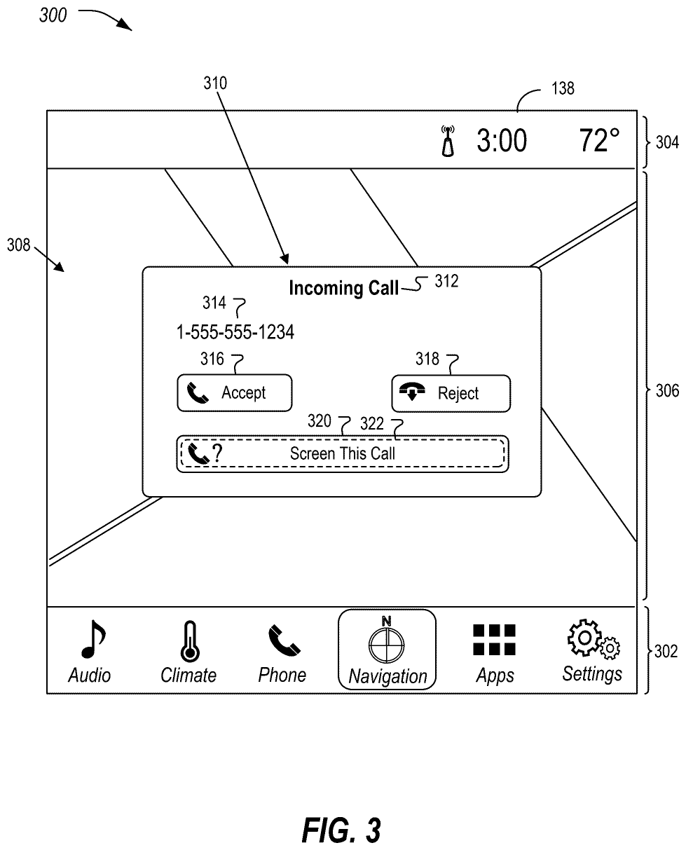

FIG. 3 illustrates an example HMI 300 for the disposition 216 of an incoming call 204. In an example, the HMI 300 may be provided by the disposition determination 218 of the call answering application 202 to a display 138 of the vehicle 102.

The illustrated HMI 300 includes a category listing 302 of one or more screens of content to be displayed in a main screen area 306. As some examples, the category listing 302 may include an audio screen from which configuration of vehicle 102 audio settings may be performed, a climate control screen from which vehicle 102 climate control settings may be configured, a phone screen from which calling services may be utilized, a navigation screen (which is selected) from which maps and routing may be performed, an applications screen from which installed applications may be invoked, and a settings screen from which backlighting or other general settings may be accessed. The HMI 300 may also include a general information area 304 from which time, current temperature, and other information may remain visible to the user, regardless of the specific screen or application that is active in the main screen area 306. In the navigation mode (as shown), the main screen area 306 illustrates a map 308 of the surroundings of the vehicle 102.

An incoming call message 310 may be overlaid on the main screen area 306 of the HMI 300 responsive to the vehicle 102 receiving an incoming call 204. As shown, the incoming call message 310 may include a title 312 that an incoming call 204 is being received.

The incoming call message 310 may further indicate call identifying information 314 of the incoming call 204. The call identifying information 314 may include information such as the number of the caller, whether the caller is in the address book 174, information gleaned about the caller from the Internet, etc.

The incoming call message 310 may also include a set of controls to allow the occupant to select a disposition 216 for the call. As shown, these controls include an accept control 316, a reject control 318, and a screen-this-call control 320.

The accept control 316 may be selectable by the occupant to allow the incoming call 204 to be completed. For example, the call may be connected to the infotainment system 104 to establish and provide an audio session between the caller and the occupants of the vehicle. In an example, the infotainment system 104 may provide the audio of the call to the occupant or occupants using the vehicle speakers 130 and may receive audio input from the occupant or occupants via the connected microphone 116. Thus, the disposition 216 of the call may be for the occupant to expressly answer the incoming call 204.

If the occupant does not desire to perform the call, the occupant may press or otherwise select the reject control 318 to decline the call. Thus, the disposition 216 of the call may be for the occupant to expressly decline the incoming call 204. In some cases, this may cause the incoming call 204 to move to voicemail. In other cases, this may simply cause the incoming call 204 to not be answered.

If the occupant expressly requests that the call answering application 202 determine whether the call should be answered, the occupant may select the screen-this-call control 320. Responsive to this selection, the call answering application 202 may perform one or more functions to determine whether the occupant should or should not connect with the caller. This may include one or more of the approaches discussed herein, including the call answering application 202 establishing a voice interface 134 session with the incoming call 204 and/or to forward or otherwise redirect the incoming call 204.

It should be noted that in some variations, the default or recommended action to be performed may be indicated by the call answering application 202 via the set of controls to allow the occupant to select a disposition 216 for the call. For instance, the suggested control to chose may be highlighted in the HMI 300 as the default or selected control. This is shown in FIG. 3 as the highlight 322. In some cases, the suggested action may be automatically performed by the call answering application 202 responsive to a timeout occurring, such as waiting three seconds or five seconds for the occupant to override the suggested disposition 216.

In cases where the occupant is unable to respond, the call answering application 202 may perform a disposition 216 to redirect the incoming call 204 to an alternative contact. This alternative contact may, in an example, be chosen by the occupant and/or maintained in the address book 174. In another example, the alternative contact may be determined by the call answering application 202, based on the call, to be police or roadside assistance.

Regarding forwarding or otherwise redirecting the incoming call 204, the call answering application 202 may perform various operations to determine where to forward the call. In an example, the vehicle 102 may be equipped with an interior camera that can employ facial recognition to identify passengers. Based on the facial recognition, the vehicle 102 may wirelessly detect and link each passenger's mobile devices 152 to the identities of the passengers. This identification may allow the call answering applications 202 to reroute calls from the driver's phone to another occupant mobile device 152. For instance, when an incoming call 204 is received, the interior camera may be used to assess who else in the vehicle 102 is not currently occupied with a call and redirects the call to one of these free occupants. The call answering application 202 may take into account the relationship between the driver and the passengers, settings 214 indicative of preferred contacts to forward the incoming call 204 to, as well as the passenger level of cognitive load 212, to determine the best candidate for call redirection.

These features may ensure that incoming calls 204 are answered despite the cognitive load 212 of the driver making it preferable for another occupant to answer the incoming call 204. Should the incoming call 204 be of importance and/or require input from the driver, the incoming call 204 can be transferred back to the mobile device 152 of the driver phone to facilitate the communication.

In other cases, the call answering application 202 may automatically choose the disposition 216. This may occur, for example, if the settings 214 indicate that the incoming call 204 is from a blocked number (e.g., to reject the incoming call 204), that the incoming call 204 is from a contact not listed in the user's address book 174 and the user's settings 214 indicate to prevent such calls (e.g., to reject the incoming call 204), if the settings 214 and/or address book 174 indicate that the caller is of a high priority (e.g., to autocatalyze accept the incoming call 204), etc.

In addition to these determinations of how to handle an incoming call 204, it should be noted that the call answering application 202 may continue to perform handling determinations while the call remains active. For instance, the call answering application 202 may update the cognitive load 212 of the occupant during the call, which may require how the call is being handled to change.

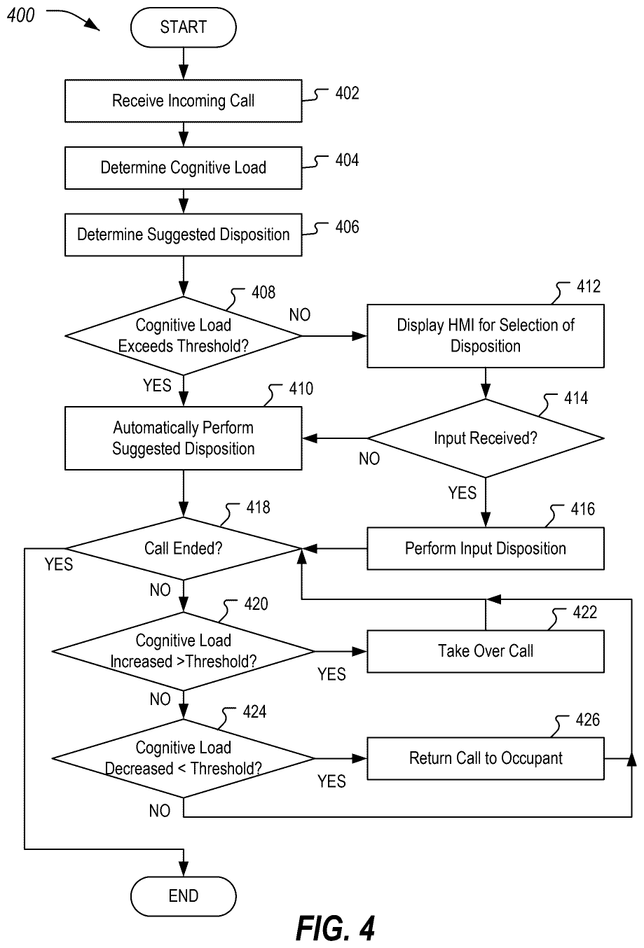

FIG. 4 illustrates an example process 400 for vehicle-based call screening and reaction. In an example, the process 400 may be performed by a call answering application 202 of the system 100 of FIG. 1.

At operation 402, the call answering application 202 receives an incoming call 204 to the vehicle 102. In an example, the infotainment system 104 may be configured to execute instructions of vehicle applications 110 to provide features such as navigation, accident reporting, satellite radio decoding. The call answering applications 202 may be one of the vehicle applications 110 and may provide hands-free calling services to the occupants. The incoming call 204 may be received to the mobile device 152 paired to and connected to the infotainment system 104, and may be a telephone call received over a cellular telephone network (e.g., the communications network 156). However, it should be noted that the incoming call 204 may be any other type of invitation to initiate a real-time voice communication between the caller of the incoming call 204 and the occupant of the vehicle 102, such as a Facetime call, a Wi-Fi call, a video call, etc.

At operation 404, the call answering application 202 determines a cognitive load 212 of the occupant of the vehicle 102. In an example, the call answering application 202 may utilize the cognitive load component 210 to determine the cognitive load 212. For instance, as discussed in detail herein, the cognitive load component 210 may compare the map data 206 and vehicle data 208 with various rules that indicate the estimated cognitive load 212 of the occupants. For instance, if speed of the vehicle 102 exceeds a predefined threshold speed, or if a turn or merge is upcoming within a predefined time period at the current speed based on the map data 206 (e.g., possibility based on the current navigation route of the vehicle 102), then cognitive load 212 may be estimated to be high. Or, if the vehicle 102 is driving down a straight roadway without detected obstacles, then cognitive load 212 may be estimated to be low. It should be noted that while operation 404 is shown as a discrete operation, the determination of the cognitive load 212 may be performed periodically and/or continuously throughout the process 400.

At operation 406, the call answering application 202 determines a suggested disposition 216 of the incoming call 204. The suggested disposition 216 may be one of to accept the call incoming call 204 (e.g., because the disposition determination 218 finds no reason not to accept the incoming call 204), reject the incoming call 204 (e.g., because the disposition determination 218 finds that the call is likely spam), that the call answering application 202 should screen the incoming call 204 further (e.g., because more information is desired such as an Internet lookup of the caller), or that the call answering application 202 should handle the incoming call 204 itself (e.g., based on the cognitive load 212 of the driver, based on settings 214 for the caller, etc.).

At operation 408, the call answering application 202 determines, whether the cognitive load 212 exceeds a cognitive threshold. In a simple example, the cognitive load component 210 may use rules that if satisfied indicate that the cognitive load 212 is high. If, in such an example, the cognitive load 212 is deemed high, control passes to operation 410. Otherwise, control passes to operation 412.

In another example, the cognitive load component 210 may determine the cognitive load 212 as a score along a scale, e.g., using a plurality of the factors discussed above. As one possibility, the cognitive load component 210 may utilize a machine learning model trained based on vehicle data 208 and predefined ground truth cognitive loads 212 for the corresponding 208, where that model is used in an inference mode by the call answering application 202 to determine the current cognitive load 212 along a scale. If the cognitive load 212 exceeds a predefined threshold of load, control passes to operation 410. Otherwise, control passes to operation 412.

At operation 410, the call answering application 202 automatically performs the suggested disposition 216 of the incoming call 204. Accordingly, the disposition 216 determined by the disposition determination 218 is performed by the call answering application 202.

At operation 412, the call answering application 202 displays, to the HMI 300 of the vehicle 102, an incoming call message 310, the incoming call message 310 indicating call identifying information 314 and providing a set of controls to allow the occupant to select a disposition 216 for the incoming call 204. In the HMI 300, the suggested disposition 216 is indicated in the incoming call message 310 as being a default disposition 216 for the incoming call 204.

In an example, the set of controls of the incoming call message 310 may include an accept control 316 that, when selected by the occupant, causes the incoming call 204 to be performed using audio features of the vehicle 102; a reject control 318 that, when selected by the occupant, causes the incoming call 204 to be rejected; and a screen-this-call control 320 that, when selected by the occupant, causes the vehicle 102 to perform one or more functions to determine whether the occupant should or should not accept the incoming call 204.

At operation 414, the call answering application 202 awaits input to the set of controls from the occupant. In an example, the call answering application 202 may wait a predefined period of time after initiating displaying of the incoming call message 310 to receive a selection from the occupant. If input is received, control passes to operation 416 to perform the indicated action. If no input is received, control passes to operation 410 to default to performing the suggested disposition 216 for the incoming call 204.

At operation 418, the call answering application 202 determines whether the call has ended. For example, the call answering application 202 may detect if the call has been terminated by the occupant or by the other party (or parties) of the call. If so, the process 400 ends. If not, control passes to operation 420.

At operation 420, the call answering application 202 determines whether the cognitive load 212 for the occupant is no longer suitable to continue the call. If so, control passes to operation 422 in which the call answering application 202 takes over the call. If not control proceeds to operation 424.

At operation 422, the call answering application 202 takes control of the call by the call answering application 202, to allow the call to remain pending until the cognitive load 212 of the occupant becomes reduced. For instance, the call answering application 202 may utilize the voice interface 134 to establish communication with the caller in place of the occupant of the vehicle. This may include, for example, the voice interface 134 performing voice prompt generation for output to the caller over the call 204, as well as the voice interface 134 performing speech recognition from audio received over the call 204. In doing so, the voice interface 134 may be used to substitute for the driver who has a high cognitive load 212, while keeping the caller on the phone.

In an example, the call answering application 202 may indicate to the caller that the occupant is temporarily busy, but that the caller should please stay on the line and the call answering applications 202 is there to answer questions. The caller of the incoming call 204 may then ask questions to the call answering application 202 such as “Have you left yet?”, “Where are you?”, or “When will you arrive?”, and the call answering application 202 may automatically provide responses based on the vehicle data 208 and navigation information of the vehicle 102, all without interrupting the driver. If the cognitive load 212 becomes reduced, control proceeds back to operation 420. After operation 422, control proceeds to operation 418.

If, at operation 424, the call answering application 202 determines that the cognitive load 212 for the occupant has become suitable to allow the occupant to perform the call, control passes to operation 426 in which the call answering application 202 drops the call back to the operator. After operation 426, and also after operation 424 if the call is not returned, control proceeds to operation 418.

Computing devices described herein, generally include computer-executable instructions where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, PL/SQL, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined not with reference to the above description, but with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for call screening for a vehicle, comprising:
receiving an incoming call to the vehicle;
determining, by a call answering application of the vehicle, based on vehicle data from one or more in-vehicle networks and map data indicative of roadway segments to be traversed by the vehicle, a cognitive load of an occupant of the vehicle;
determining, by the call answering application, a suggested disposition of the incoming call;
responsive to the cognitive load exceeding a cognitive threshold, automatically performing the suggested disposition of the incoming call; and
otherwise, displaying, to a human-machine interface (HMI) of the vehicle, an incoming call message, the incoming call message indicating call identifying information and providing a set of controls to allow the occupant to select a disposition for the incoming call,
wherein the suggested disposition is indicated in the incoming call message as being a default disposition for the incoming call.

2. The method of claim 1, wherein the set of controls include:
an accept control that, when selected by the occupant, causes the incoming call to be performed using audio features of the vehicle;
a reject control that, when selected by the occupant, causes the incoming call to be rejected; and
a screen-this-call control that, when selected by the occupant, causes the vehicle to perform one or more functions to determine whether the occupant should or should not accept the incoming call.

3. The method of claim 1, further comprising performing the default disposition for the incoming call responsive to a lack of occupant input to the set of controls within a predefined period of time since the incoming call message was displayed.

4. The method of claim 1, further comprising:
determining, by the call answering application while the incoming call is being performed using audio features of the vehicle, that the cognitive load for the occupant is no longer suitable to continue the call; and
assuming control of the call by the call answering application, to allow the call to remain pending until the cognitive load of the occupant becomes reduced.

5. The method of claim 4, wherein assuming control of the call includes the call answering application initiating a voice interface session with the incoming call.

6. The method of claim 1, wherein the suggested disposition is the call answering application initiating a voice interface session with the incoming call.

7. The method of claim 6, further comprising indicating, by the call answering application to the caller, that although the occupant is temporarily busy, to stay on the call and the call answering application is available to answer questions.

8. The method of claim 7, wherein the call answering application provides responses to questions received over the call using the vehicle data.

9. A system for call screening for a vehicle, comprising:
one or more controllers of a vehicle, configured to:
receive an incoming call to the vehicle;
determine, by a call answering application of the vehicle, based on vehicle data from one or more in-vehicle networks and map data indicative of roadway segments to be traversed by the vehicle, a cognitive load of an occupant of the vehicle;
determine, by the call answering application, a suggested disposition of the incoming call;
responsive to the cognitive load exceeding a cognitive threshold, automatically perform the suggested disposition of the incoming call; and
otherwise, display, to a human-machine interface (HMI) of the vehicle, an incoming call message, the incoming call message indicating call identifying information and providing a set of controls to allow the occupant to select a disposition for the incoming call,
wherein the suggested disposition is indicated in the incoming call message as being a default disposition for the incoming call.

10. The system of claim 9, wherein the set of controls include:
an accept control that, when selected by the occupant, causes the incoming call to be performed using audio features of the vehicle;
a reject control that, when selected by the occupant, causes the incoming call to be rejected; and
a screen-this-call control that, when selected by the occupant, causes the vehicle to perform one or more functions to determine whether the occupant should or should not accept the incoming call.

11. The system of claim 9, wherein the one or more controllers of a vehicle are further configured to perform the default disposition for the incoming call responsive to a lack of occupant input to the set of controls within a predefined period of time since the incoming call message was displayed.

12. The system of claim 9, wherein the one or more controllers of a vehicle are further configured to:
determine, by the call answering application while the incoming call is being performed using audio features of the vehicle, that the cognitive load for the occupant is no longer suitable to continue the call; and
assume control of the call by the call answering application, to allow the call to remain pending until the cognitive load of the occupant becomes reduced.

13. The system of claim 12, wherein assuming control of the call includes the call answering application initiating a voice interface session with the incoming call.

14. The system of claim 9, wherein the suggested disposition is the call answering application initiating a voice interface session with the incoming call.

15. The system of claim 14, wherein the one or more controllers of a vehicle are further configured to indicate, by the call answering application to the caller, that although the occupant is temporarily busy, to stay on the call and the call answering application is available to answer questions.

16. The system of claim 15, wherein the one or more controllers of a vehicle are further configured to provides responses to questions received over the call using the vehicle data.

17. A non-transitory computer-readable medium comprising instructions for a call screening for a vehicle that, when executed by one or more controllers of a vehicle, cause the one or more controllers to perform operations including to:
receive an incoming call to the vehicle;
determine, by a call answering application of the vehicle, based on vehicle data from one or more in-vehicle networks and map data indicative of roadway segments to be traversed by the vehicle, a cognitive load of an occupant of the vehicle;
determine, by the call answering application, a suggested disposition of the incoming call;
responsive to the cognitive load exceeding a cognitive threshold, automatically perform the suggested disposition of the incoming call; and
otherwise, display, to a human-machine interface (HMI) of the vehicle, an incoming call message, the incoming call message indicating call identifying information and providing a set of controls to allow the occupant to select a disposition for the incoming call,
wherein the suggested disposition is indicated in the incoming call message as being a default disposition for the incoming call.

18. The medium of claim 17, further comprising instructions that, when executed by the one or more controllers of the vehicle, cause the one or more controllers to perform operations including to perform the default disposition for the incoming call responsive to a lack of occupant input to the set of controls within a predefined period of time since the incoming call message was displayed, wherein the default disposition is initiating a voice interface session with the incoming call.

19. The medium of claim 17, further comprising instructions that, when executed by the one or more controllers of the vehicle, cause the one or more controllers to perform operations including to:
determine, by the call answering application while the incoming call is being performed using audio features of the vehicle, that the cognitive load for the occupant is no longer suitable to continue the call; and
assume control of the call by the call answering application, to allow the call to remain pending until the cognitive load of the occupant becomes reduced.

20. The medium of claim 17, further comprising instructions that, when executed by the one or more controllers of the vehicle, cause the one or more controllers to perform operations including to indicate, by the call answering application to the caller, that although the occupant is temporarily busy, to stay on the call and the call answering application is available to answer questions.
